(19) United States
(12) Patent Application Publication
(10) Pub. No.: US 2019/0143610 A1
(43) Pub. Date: May 16, 2019

(54) Method And Apparatus For Detection Of Loose Stack Joints And Cracked Components Of Ultrasonic Stacks

(71) Applicant: Branson Ultrasonics Corporation, Danbury, CT (US)

(72) Inventors: Scott CALDWELL, New Milford, CT (US); Tom AYARS, Danbury, CT (US)

(73) Assignee: Branson Ultrasonics Corporation, Danbury, CT (US)

(21) Appl. No.: 16/162,724

(22) Filed: Oct. 17, 2018

Related U.S. Application Data
(60) Provisional application No. 62/586,246, filed on Nov. 15, 2017.

(51) Int. Cl. B29C 65/00; B23K 20/10; B29C 65/08

(52) U.S. Cl. CPC B29C 66/961; B23K 20/10; B29C 66/9511; B29C 66/9512; B29C 65/08

(57) ABSTRACT

A loose stack joint and/or cracked ultrasonic stack component of an ultrasonic stack of an ultrasonic device are detected by measuring a test damping coefficient with a test scan of the ultrasonic stack. The test damping coefficient is compared with a previously measured baseline damping coefficient. It is determined that the ultrasonic stack has a loose stack joint and/or a cracked ultrasonic stack component when the damping coefficient is greater than the baseline damping coefficient by more than a predetermined amount.

### CROSS-REFERENCE TO RELATED APPLICATIONS

This application claims the benefit of U.S. Provisional Application No. 62/586,246 filed on Nov. 15, 2017. The entire disclosure of the above application is incorporated herein by reference.

### FIELD

The present disclosure relates to ultrasonic devices having an ultrasonic stack, and more particularly, to automatic detection of loose stack joints and cracks in components of ultrasonic stacks.

### BACKGROUND

This section provides background information related to the present disclosure which is not necessarily prior art.

Certain ultrasonic devices have an ultrasonic stack excited by a power supply, which is often also used to control the ultrasonic device. An ultrasonic stack includes an ultrasonic converter and any component ultrasonically coupled to the ultrasonic converter, typically a booster and an ultrasonic horn. Examples of such ultrasonic devices include ultrasonic welders such as those used to weld together metal parts, those used to weld together plastic parts, and those used to seal ends of metal or plastic tubes (which are essentially the same as those used to weld together metal or plastic parts).

FIG. 1 shows a model of an ultrasonic stack 102 and power supply 104 of a typical ultrasonic device 100. It should be understood that ultrasonic device 100 can be any type of ultrasonic device that has an ultrasonic stack excited by a power supply. Typical components of ultrasonic stack 102 include an ultrasonic converter 106, a booster 108 and an ultrasonic horn 110. It should be appreciated that not every ultrasonic stack 102 includes booster 108. It should be further appreciated that not every ultrasonic stack 102 includes ultrasonic horn 110. Ultrasonic horn 110 will often have one or more ultrasonic horn tips (not shown). Booster 108 and ultrasonic horn 110 are ultrasonically connected (directly or via another component) to ultrasonic converter 106. In the example of FIG. 1, booster 108 is mounted to ultrasonic converter 106 ultrasonically connecting booster 108 to ultrasonic converter 106, thereby providing stack joint 122, and ultrasonic horn 110 is mounted to booster 108 ultrasonically connecting ultrasonic horn 110 to booster 108, thereby providing stack joint 120, and thus ultrasonically connecting ultrasonic horn 110 to ultrasonic converter 106 via booster 108. It should be understood that ultrasonic converters are also known in the art as ultrasonic transducers and these terms are used interchangeably. Power supply 104 is controlled by a controller 114 that includes memory 116. It should be understood that controller 114 can be included in power supply 104 or separate from power supply 104. Ultrasonic device 100 will often include an anvil (not shown) on which a work piece to be processed will be supported and contacted by the ultrasonic horn tip when it is being processed. For example, if two metal or plastic parts are being welded together, they are supported on the anvil and pressed together by the ultrasonic horn tip during the weld process that also ultrasonically vibrates against one of the parts to ultrasonically weld the two parts together. Further, an actuator (not shown) moves either or both of ultrasonic stack 102 and the parts to be welded together towards or away from one another.

Ultrasonic stacks can sometimes develop cracks in their components, and the joints forming the mechanical connections between the components of ultrasonic stacks can become loose. These joints are referred to herein as stack joints. Such a loose stack joint or crack will hinder the effectiveness of the ultrasonic stack, thereby yielding poor ultrasonic performance and can lead to overloads of the power supply. Accordingly, the operator needs to know whether cracked ultrasonic stack components need to be replaced and when loose stack joints need to be tightened. But neither loose stack joints nor cracks in stack components are necessarily visible to the naked eye. Cracks also may not be visible because the component (e.g., ultrasonic converter) of the ultrasonic stack having the crack is enclosed in a housing.

Present methods to detect cracks include applying a foaming surfactant or an alcohol on the ultrasonic stack itself then running the ultrasonic device to detect cracks. As an example, dark lines will form along cracks after applying an alcohol on the ultrasonic stack followed by running the ultrasonic device. Such methods, however, are time consuming, as they may require disassembly (e.g., removing a housing covering the ultrasonic converter). Further, piecemeal testing like this is not practical during normal operation, especially for ultrasonic devices then in use on production. Moreover, if a crack is not detected, and instead, for example, there is a loose stack joint between the components of the stack, application of the foaming surfactant or alcohol can adversely affect the quality of subsequent welds by the ultrasonic stack.

### SUMMARY

This section provides a general summary of the disclosure, and is not a comprehensive disclosure of its full scope or all of its features.

In accordance with an aspect of the present disclosure, a method of detecting whether any stack joint of an ultrasonic stack of an ultrasonic device is loose or any ultrasonic stack component of the ultrasonic stack is cracked includes performing with a power supply of the ultrasonic device a test scan of the ultrasonic stack in air, measuring a damping coefficient with the test scan of the ultrasonic stack, and comparing the damping coefficient with a previously measured baseline damping coefficient and determining that a stack joint is loose or an ultrasonic stack component is cracked when the test damping coefficient is greater than the baseline damping coefficient by more than a predetermined amount.

In accordance with an aspect, the baseline damping coefficient is established by performing with the power supply of the ultrasonic device a baseline scan of the ultrasonic stack in air when each ultrasonic stack component is known to be good and measuring a damping coefficient with the baseline scan of the ultrasonic stack.

In accordance with an aspect, the baseline damping coefficient is stored in memory of a controller as the baseline damping coefficient and the controller compares the test damping coefficient to the baseline damping coefficient and determines that a stack joint is loose or an ultrasonic stack component is cracked when the test damping coefficient is greater than the baseline damping coefficient by more than the predetermined amount. In accordance with an aspect, the controller provides an alert upon determining the presence of a loose stack joint or a cracked ultrasonic stack component. In accordance with an aspect, the alert includes alerting an operator to tighten each ultrasonic stack joint to the factory specified torques and then measuring the damping coefficient with an additional test scan of the ultrasonic stack. In accordance with an aspect, the controller provides a cracked ultrasonic stack component alert upon the controller determining via the additional test scan of the ultrasonic stack that the damping coefficient is still higher than the baseline damping coefficient by more than the predetermined amount.

In accordance with another aspect, the baseline damping coefficient is established at parallel resonance.

In accordance with another aspect, the baseline damping coefficient is established at series resonance.

In accordance with a further aspect, an ultrasonic welding apparatus includes an ultrasonic stack, an actuator, a power supply, and a controller. The actuator moves either or both of the ultrasonic stack and plurality of work pieces towards or away from one another. The power supply is electrically connected to the ultrasonic stack and the actuator. And the controller is for controlling the power supply and is configured to run a test scan of the ultrasonic stack at a time when the ultrasonic stack is in air to measure a baseline damping coefficient of the ultrasonic stack. The controller further comprises a memory for storing the test scan damping coefficient measured by the power supply, and the controller is further configured to monitor changes in the damping coefficient and provide an alert when the damping coefficient changes by a predetermined amount.

In another aspect, the power supply is configured to measure the baseline damping coefficient when the ultrasonic stack is running at parallel resonance.

In another aspect, the power supply is configured to measure the baseline damping coefficient when the ultrasonic stack is running at series resonance.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a simplified diagram of a typical prior art ultrasonic device;

FIG. 2 is a chart showing a typical prior art scan of an ultrasonic stack of the ultrasonic device of FIG. 1;

FIG. 3 is a flow chart of a control routine in accordance with an aspect of the present disclosure for detecting any stack joint of an ultrasonic stack is loose or any ultrasonic stack component of the ultrasonic stack is cracked; and

FIG. 4 is a flow chart of a control routine in accordance with another aspect of the present disclosure for detecting whether any stack joint of an ultrasonic stack is loose or any ultrasonic stack component of the ultrasonic stack is cracked.

Corresponding reference numerals indicate corresponding parts throughout the several views of the drawings.

### DETAILED DESCRIPTION

Example embodiments will now be described more fully with reference to the accompanying drawings.

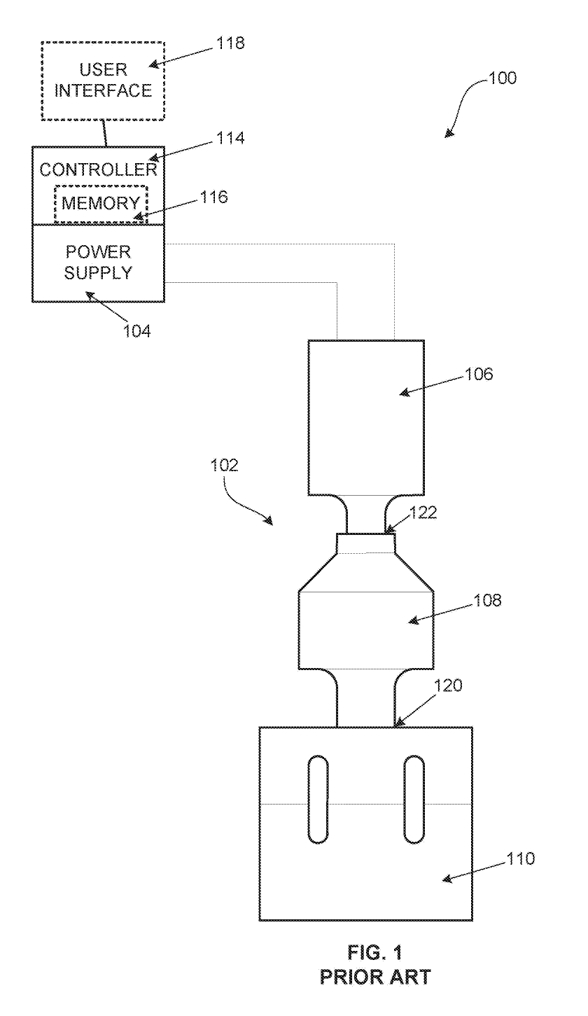

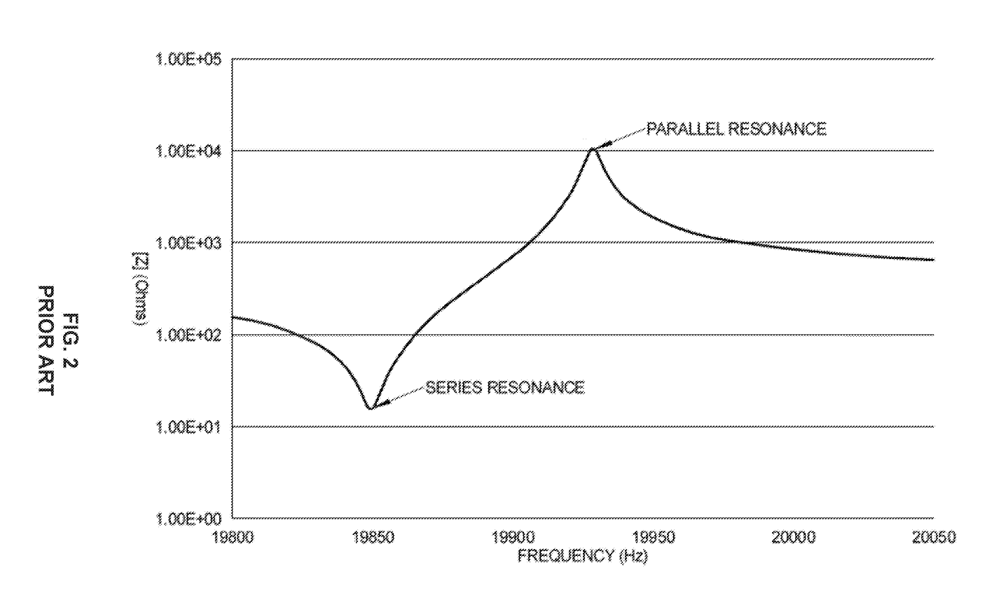

The following discussion will be with reference to ultrasonic device 100 of FIG. 1, but it should be understood that the following applies to any ultrasonic device that has an ultrasonic stack excited by a power supply. In this regard, it should be understood that the method of detecting whether any stack joint is loose or any ultrasonic stack component is cracked (that is, has one or more cracks in it) in accordance with an aspect of the present disclosure as described below differs from methods used in prior art ultrasonic devices and the indication that FIGS. 1 and 2 are prior art does not mean that the below described method is in the prior art. Further, as noted above, ultrasonic stack 102 may or may not comprise either or both of booster 108 or ultrasonic horn 110. Thus, in some embodiments there is no stack joint 120, as there is no booster 108; there is no stack joint 120, as there is no ultrasonic horn 110; or there is no stack joint 122, as there is no booster 108. Further, in such embodiments where there is no booster 108 but there is ultrasonic converter 106 and ultrasonic horn 110, there is a stack joint connecting ultrasonic converter 106 and ultrasonic horn 110. Appropriate ultrasonic stacks include axial, transverse, and twisting stacks with one or more converters, none or more boosters, and none or more horns.

In accordance with an aspect of the present disclosure, a damping coefficient is measured and compared to a baseline damping coefficient previously measured. An increased damping coefficient correlates to a loose stack joint (e.g., at stack joint 120 or stack joint 122) or a cracked ultrasonic stack component of ultrasonic stack 102. Thus, the comparison of the measured damping coefficient to a baseline damping coefficient previously measured is used to detect at least a loose stack joint and/or at least a cracked ultrasonic stack component of ultrasonic stack 102. The damping coefficient may be determined heuristically for ultrasonic stack 102 or theoretically. As can be seen in FIG. 2, a typical scan of ultrasonic stack 102 will have a parallel resonant frequency, which is at the highest impedance, and a series resonant frequency, which is the lowest impedance at a frequency below the parallel resonance. An increase in the damping coefficient lowers the impedance of the parallel resonant frequency and raises the impedance of the series resonant frequency. Therefore a decrease in the impedance of the parallel resonant frequency signifies an increase of the damping coefficient, whereas an increase in the impedance of the series resonant frequency signifies an increase of the damping coefficient. It has been found that a loose mechanical stack joint raises the damping coefficient. Similarly, a cracked ultrasonic stack component of ultrasonic stack 102 raises the damping coefficient.

In accordance with an aspect of the present disclosure, a baseline damping coefficient is established by power supply 104 under control of controller 112 performing a baseline scan of ultrasonic stack 102 in air (e.g., when ultrasonic stack 102 is not in contact with a plurality of work pieces, which can be accomplished by using the actuator to move either or both of ultrasonic stack 102 and the plurality of work pieces away from one another) with a good ultrasonic stack 102. As used herein, a scan of ultrasonic stack 102 is a frequency sweep of the ultrasonic stack 102 by power supply 104 in which the voltage and current delivered to the ultrasonic converter 106 at each frequency in the frequency sweep are measured. The frequency steps of the frequency sweep depend on the fidelity that is desired with 1 Hz frequency steps being typical. The determined baseline damping coefficient may be stored in memory 116. As used herein, the term good ultrasonic stack means an ultrasonic stack that has each of its stack joints tightened appropriately (e.g., to manufacturer specifications) and each ultrasonic stack component is without cracks. The baseline scan is therefore for example performed during the original assembly of ultrasonic device 100 after tightening each of the stack joints of the ultrasonic stack 102 to manufacturer specified torques or after initial set up of ultrasonic device 100 for operation in a production facility after tightening each of the stack joints of ultrasonic stack 102 to manufacturer specified torques. The baseline scan is performed in air. Thereafter, when it is desired to determine if any of the stack joints 120 and/or 122 are loose or if one or more of the ultrasonic stack components of ultrasonic stack 102 has a crack, a test frequency scan of ultrasonic stack 102 in air is performed by power supply 104 and the damping coefficient is measured by controller 114. If the value of the damping coefficient is greater than the baseline damping coefficient by more than a predetermined amount, controller 114 determines that one or both of a crack or a loose stack joint has occurred. In an aspect, controller 114 provides an alert that the ultrasonic stack 102 has at least one of a loose stack joint or a cracked ultrasonic stack component. By way of example and not of limitation, the alert can be a visual indicator illuminated by controller 114, a message on a screen of a user interface, such as user interface 118 shown in phantom in FIG. 1, a message sent to a remote system monitoring ultrasonic device 100, or any combination of the foregoing. In another aspect, the alert instructs the operator of ultrasonic device 100 to tighten each of the stack joints of ultrasonic stack 102 to their manufacturer specified torques, followed by rerunning a test frequency scan of ultrasonic stack 102 in air performed by power supply 104 wherein the damping coefficient is measured by controller 114. If the value of the damping coefficient is still greater than the baseline damping coefficient by more than a predetermined amount, controller 114 determines that there an ultrasonic stack component of ultrasonic stack 102 is cracked. If, on the other hand, the value of the damping coefficient returns to the baseline damping coefficient, the operator is notified that ultrasonic stack 102 is once again ready for use in production.

It should be understood that neither the baseline damping coefficient nor any subsequent damping coefficient need actually be calculated to determine that ultrasonic stack 102 has at least one of a loose stack joint or cracked ultrasonic stack component. Rather, in such cases what is contemplated is that the baseline damping coefficient, taken by performing a baseline scan of a good ultrasonic stack 102 in air, is compared against a subsequently measured damping coefficient of that ultrasonic stack 102 in air while otherwise using the same constants. For example, if the baseline damping coefficient is detected by testing a good ultrasonic stack in air while running at parallel resonance, to accurately determine whether there has been an increase in a subsequent damping coefficient the subsequent damping coefficient is detected by testing that ultrasonic stack in air while running at parallel resonance. Similarly, if the baseline damping coefficient is detected by testing a good ultrasonic stack in air while running at series resonance, increases in damping coefficients are uncovered by detecting the damping coefficient by testing that ultrasonic stack in air while running at series resonance.

On the other hand, it is also contemplated that the baseline damping coefficient may be calculated in some embodiments, e.g., by controller 114, where the calculated baseline damping coefficient may be stored in memory 116. Under such embodiments, it is not necessary that a subsequent measurement of the damping coefficient be made with the same constants. Rather, it is contemplated that a subsequent measurement would be used by controller 114 to calculate the damping coefficient, which would be then compared against the previously calculated and stored baseline damping coefficient. As discussed above, an increase in the damping coefficient signifies at least a loose stack joint and/or at a cracked ultrasonic component of that ultrasonic stack 102.

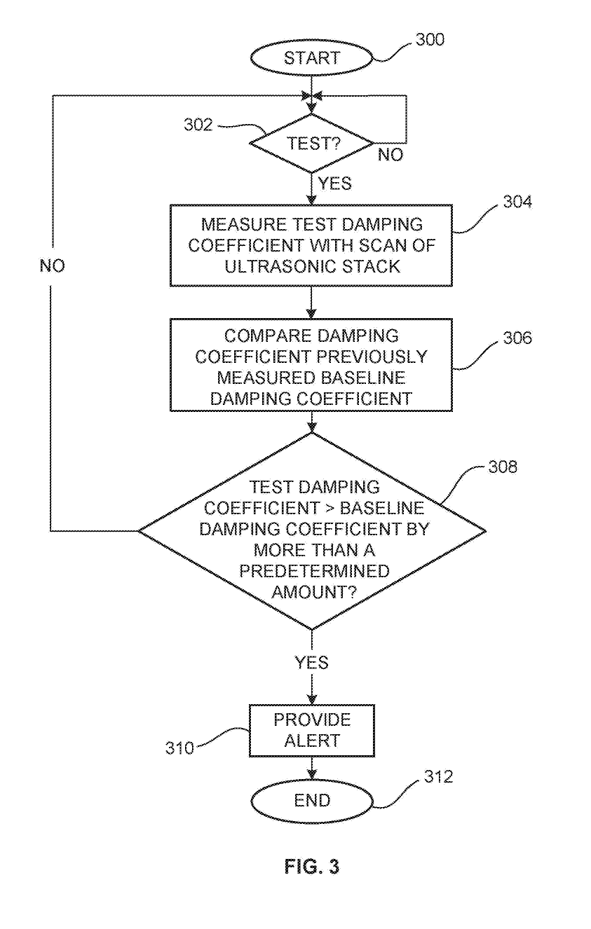

FIG. 3 is a flow chart of a control routine, illustratively implemented in controller 114, for the above described method of detecting whether there is a loose stack joint or cracked ultrasonic stack component of an ultrasonic stack of an ultrasonic device. The control routine starts at 300. At 302, the control routine checks whether the ultrasonic stack of the ultrasonic device is to be tested to determine if there is a loose stack joint or cracked ultrasonic stack component of the ultrasonic stack of the ultrasonic device. If not, the control routine branches back to 302. If the ultrasonic stack is to be tested, the control routine proceeds to 304 where the test damping coefficient is measured with a scan of the ultrasonic stack in air as described above. The control routine then proceeds to 306 where the controller compares the test damping coefficient to the previously measured baseline damping coefficient and proceeds to 308. At 308, the control routine checks whether the test damping coefficient is greater than the baseline damping coefficient by more than a predetermined amount. If not, the control routine determines that there is not a loose stack joint or cracked ultrasonic stack component of the ultrasonic stack of the ultrasonic device and branches back to 302. If the test damping coefficient is greater than the baseline damping coefficient by more than the predetermined amount, the control routine determines that there is at least one of a loose stack joint or cracked ultrasonic stack component of the ultrasonic stack of the ultrasonic device and proceeds to 310 where an alert is provided (e.g., by the controller), as discussed above, and then ends at 312.

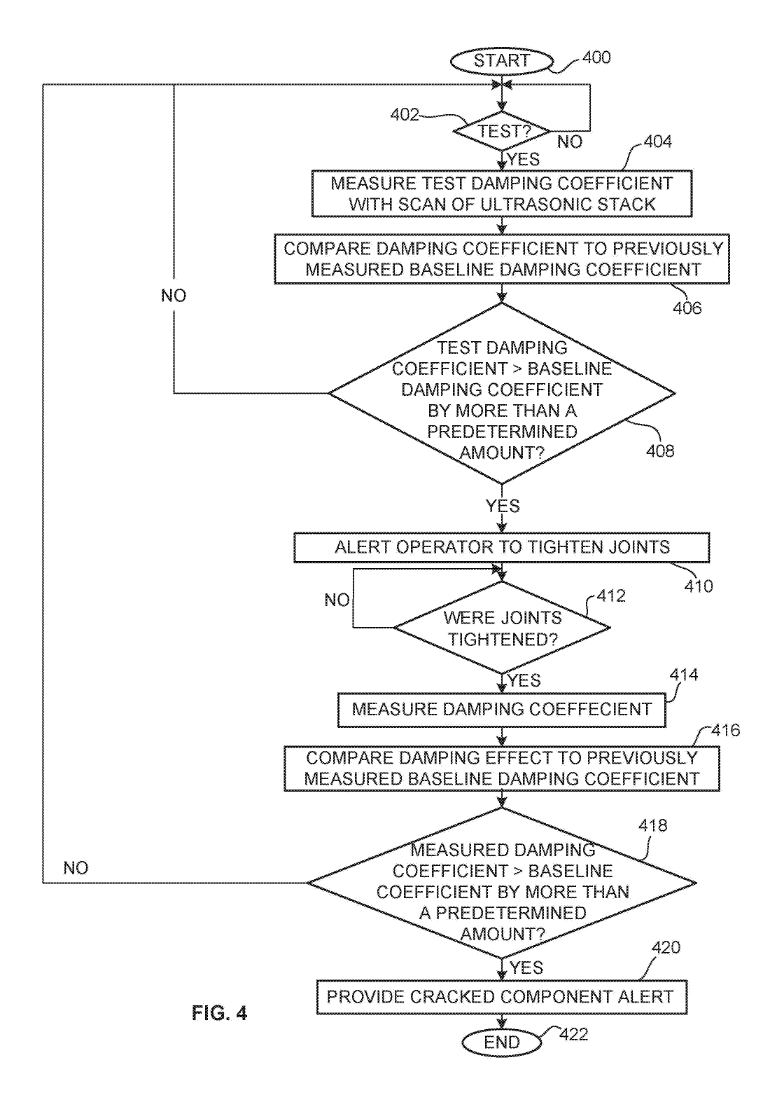

FIG. 4 is a flow chart of a variation of the control routine of FIG. 3, illustratively implemented in controller 114, for the above described method of detecting whether there is a loose stack joint or cracked ultrasonic stack component of an ultrasonic stack of an ultrasonic device that distinguishes between a loose stack joint and a cracked ultrasonic stack component. The control routine starts at 400. At 402, the control routine checks whether the ultrasonic stack of the ultrasonic device is to be tested to determine if there is a loose stack joint or cracked ultrasonic stack component of the ultrasonic stack of the ultrasonic device. If not, the control routine branches back to 402. If the ultrasonic stack is to be tested, the control routine proceeds to 404 where the test damping coefficient is measured with a scan of the ultrasonic stack in air as described above. The control routine then proceeds to 406 where the controller compares the test damping coefficient to the previously measured baseline damping coefficient and proceeds to 408. At 408, the control routine checks whether the test damping coefficient is greater than the baseline damping coefficient by more than a predetermined amount. If not, the control routine determines that there is not a loose stack joint or cracked ultrasonic stack component of the ultrasonic stack of the ultrasonic device and branches back to 402. If the test damping coefficient is greater than the baseline damping coefficient by more than the predetermined amount, the control routine determines that there is at least one of a loose stack joint or cracked ultrasonic stack component of the ultrasonic stack of the ultrasonic device and proceeds to 410, where an alert issues to an operator to tighten each of the stack joints of the ultrasonic stack. At 412, the control routine checks whether the applicable stack joints were tightened. This may for example be by the operator providing an input that the joints were tightened. If not, the control routine returns to 410, otherwise, the control routine proceeds to 414, and the damping coefficient is again measured with a scan of the ultrasonic stack in air as described above. The control routine then proceeds to 416, where the controller compares the test damping coefficient to the measurement scanned at 414. At control routine step 418, the controller determines whether the damping coefficient measurement scanned at 414 is greater than the baseline damping coefficient by more than a predetermined amount. If not, the control routine determines that there is not an cracked ultrasonic stack component of the ultrasonic stack of the ultrasonic device and branches back to 402. Otherwise, the control routine proceeds to 420 and provides an alert that a cracked ultrasonic stack component was discovered (e.g., by the controller), as above, and then ends at 422.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

As used herein, the term controller, control module, control system, or the like may refer to, be part of, or include an Application Specific Integrated Circuit (ASIC); an electronic circuit; a combinational logic circuit; a field programmable gate array (FPGA); a processor (shared, dedicated, or group) that executes code; a programmable logic controller, programmable control system such as a processor based control system including a computer based control system, a process controller such as a PID controller, or other suitable hardware components that provide the described functionality or provide the above functionality when programmed with software as described herein; or a combination of some or all of the above, such as in a system-on-chip. The term module may include memory (shared, dedicated, or group) that stores code executed by the processor. When it is stated that such a device performs a function, it should be understood that the device is configured to perform the function by appropriate logic, such as software, hardware, or a combination thereof.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A method of detecting whether an ultrasonic stack of an ultrasonic device has a loose stack joint or cracked ultrasonic stack component, comprising:
performing with a power supply of the ultrasonic device a test scan of the ultrasonic stack in air, measuring a damping coefficient with the test scan of the ultrasonic stack, comparing the damping coefficient with a previously measured baseline damping coefficient and determining that the ultrasonic stack has a loose stack joint or a cracked ultrasonic stack component when the test damping coefficient is greater than the baseline damping coefficient by more than a predetermined amount.

2. The method of claim 1 including establishing the baseline damping coefficient by performing with the power supply of the ultrasonic device a baseline scan of the ultrasonic stack in air when each ultrasonic stack component is known to be good and measuring the baseline damping coefficient with the baseline scan of the ultrasonic stack.

3. The method of claim 2 including storing the baseline damping coefficient in memory of a controller as the baseline damping coefficient and having the controller compare the test damping coefficient to the baseline damping coefficient and determine that the ultrasonic stack has a loose stack joint or a cracked ultrasonic stack component when the test damping coefficient is greater than the baseline damping coefficient by more than the predetermined amount.

4. The method of claim 3 including having the controller provide an alert upon determining that the ultrasonic stack has a loose stack joint or a cracked ultrasonic stack component.

5. The method of claim 4 wherein having the controller provide the alert includes alerting an operator to tighten each the stack joint to factory specified torques and then measuring the damping coefficient with an additional test scan of the ultrasonic stack.

6. The method of claim 5, wherein the controller provides a cracked ultrasonic stack component alert upon the controller determining via the additional test scan of the ultrasonic stack that the damping coefficient is still higher than the baseline damping coefficient by more than the predetermined amount.

7. The method of claim 2, wherein establishing the baseline damping coefficient includes establishing it at parallel resonance.

8. The method of claim 2, wherein establishing the baseline damping coefficient includes establishing it at series resonance.

9. An ultrasonic welding apparatus, the ultrasonic welding apparatus comprising:
an ultrasonic stack;
an actuator for moving either or both of the ultrasonic stack towards and a plurality of work pieces towards or away from one another;
a power supply electrically connected to the ultrasonic stack and the actuator; and
a controller for controlling the power supply, wherein the controller is configured to run a test scan of the ultrasonic stack at a time when the ultrasonic stack is in air to measure a baseline damping coefficient of the ultrasonic stack, wherein the controller comprises a memory for storing the test scan damping coefficient measured by the power supply, and wherein the controller is further configured to monitor changes in the damping coefficient and provide an alert when the damping coefficient changes by a predetermined amount.

10. The ultrasonic welding apparatus of claim 9, wherein the power supply is configured to measure the baseline damping coefficient when the ultrasonic stack is running at parallel resonance.

11. The ultrasonic welding apparatus of claim 9, wherein the power supply is configured to measure the baseline damping coefficient when the ultrasonic stack is running at series resonance.
